(19) United States
(12) Patent Application Publication
(10) Pub. No.: US 2018/0225886 A1
(43) Pub. Date: Aug. 9, 2018

(54) METHOD AND APPARATUS FOR EXECUTING AN ELECTRONIC MONEY TRANSFER IN ORDER TO PAY A PARKING FEE

(71) Applicant: Robert Bosch GmbH, Stuttgart (DE)

(72) Inventors: Manuel Carrara, Heilbronn (DE); Stefan Nordbruch, Kornwestheim (DE)

(21) Appl. No.: 15/884,057

(22) Filed: Jan. 30, 2018

(30) Foreign Application Priority Data
Feb. 8, 2017 (DE) 102017201938.7

(51) Int. Cl. G07B 15/00; G06Q 20/40; G06K 9/00

(52) U.S. Cl. CPC G07B 15/00; G06K 9/00288; G06K 9/00255; G06Q 20/40145

(57) ABSTRACT

A method for executing an electronic money transfer in order to pay a parking fee, including the steps: taking a photograph of a driver of a motor vehicle for which a parking fee must be paid, detecting a face of the driver in the photograph taken, comparing the detected face to a reference face, and initiating an electronic money transfer to pay the parking fee if the detected face agrees with the reference face. A corresponding apparatus, a corresponding parking facility, and a computer program, are also described.

### CROSS REFERENCE

The present application claims the benefit under 35 U.S.C. § 119 of German Patent Application No. DE 102017201938.7 filed on Feb. 8, 2017, which is expressly incorporated herein by reference in its entirety.

### FIELD

The present invention relates to a method and an apparatus for executing an electronic money transfer, in order to pay a parking fee. The present invention also relates to a parking facility for motor vehicles, as well as a computer program.

### BACKGROUND INFORMATION

The German Patent Application No. DE 10 2013 213 748 A1 describes a method and a device for monitoring a parking authorization of a motor vehicle.

German Patent No. DE 101 26 050 A1 describes a method for user recognition.

### SUMMARY

An object of the present invention includes providing for the efficient execution of an electronic money transfer, in order to pay a parking fee.

This objective may be achieved in accordance with the present invention. Advantageous developments of the present invention are described herein.

According to one aspect of the present invention, an example method is provided for executing an electronic money transfer in order to pay a parking fee, including the following steps:
Taking a photograph of a driver of a motor vehicle for which a parking fee must be paid;
Detecting a face of the driver in the photograph taken;
Comparing the detected face to a reference face;
Initiating an electronic money transfer to pay the parking fee if the detected face agrees with the reference face.

According to a further aspect of the present invention, an apparatus is provided for executing an electronic money transfer in order to pay a parking fee, including:
a camera for taking a photograph of a driver of a motor vehicle for which a parking fee must be paid;
a processor for detecting a face of the driver in the photograph taken and
for comparing the detected face to a reference face;
the processor being designed to initiate an electronic money transfer to pay the parking fee if the detected face agrees with the reference face.

According to another aspect of the present invention, a parking facility for motor vehicles is provided, the parking facility including the apparatus for executing an electronic money transfer in order to pay a parking fee.

According to a further aspect of the present invention, a computer program is provided which includes program code for carrying out the method for executing an electronic money transfer in order to pay a parking fee, when the computer program is executed on a computer, particularly on the processor of the apparatus.

Example embodiments of the present invention use facial recognition of the driver of the motor vehicle for which a parking fee must be paid, to decide whether or not the electronic money transfer should be initiated to pay the parking fee.

A basis for the decision as to whether or not the electronic money transfer should be initiated in order to pay the parking fee is thus linked to the driver of the motor vehicle. In particular, this provides the technical advantage that the driver is also able to pay a parking fee for different motor vehicles. If the basis as to whether or not the electronic money transfer should be initiated is coupled exclusively to a specific motor vehicle, the driver is unable to initiate an electronic money transfer for a different motor vehicle.

Thus, the driver is advantageously provided with the possibility of parking with different motor vehicles and also paying the corresponding parking fee for these different motor vehicles by the initiation of the electronic money transfer.

Because the electronic money transfer is initiated if the detected face matches up with the reference face, the driver no longer necessarily has to leave his vehicle and go to an automated pay machine. For example, this therefore yields the technical advantage that a payment process may be carried out faster in comparison to the case in which the driver would have to go to an automated pay machine.

In summary, a technical advantage may thus be achieved, that an efficient execution of an electronic money transfer in order to pay a parking fee is provided.

According to one specific embodiment of the present invention, the photograph is taken at a parking-facility exit blocked by a barrier, the barrier opening automatically after the electronic money transfer has been initiated, in order to allow the motor vehicle to exit.

For example, this yields the technical advantage that it is possible to ensure effectually that the driver cannot drive out of the parking facility with his motor vehicle until the electronic money transfer has been initiated. For example, the technical advantage is thus provided, that the driver of the motor vehicle may be prevented effectively from driving out of the parking facility without paying the parking fee.

In addition, this yields the technical advantage that the driver, as is generally customary, no longer has to insert a parking ticket into a ticket machine in the vicinity of the barrier in order for the barrier to open. Thus, for example, the driver no longer has to wind down or bring down a window of the motor vehicle for this process.

Notably, the exiting process is thereby made more efficient.

According to one specific embodiment of the present invention, in the event the detected face agrees with the reference face, a message about the initiation of the electronic money transfer is transmitted to a network address via a communication network.

For example, the technical advantage may thereby be obtained that the message about the initiation of the electronic money transfer may be provided in an efficient manner.

In one specific embodiment of the present invention, in the event the detected face agrees with the reference face, prior to initiating the electronic money transfer, a request for a confirmation of the money transfer is transmitted to a network address via a communication network, the electronic money transfer only being initiated upon receipt of the confirmation via the communication network.

For example, this yields the technical advantage that misuse may effectively be prevented, for according to this specific embodiment, an explicit confirmation is now provided, permitting the electronic money transfer to be initiated.

For example, a network address within the meaning of the specification is assigned to a terminal, e.g., a mobile terminal, e.g., a cell phone. For instance, the terminal is included by the motor vehicle. For example, the terminal is permanently installed in the motor vehicle. The terminal is included by a main control device of the motor vehicle, for example.

The terminal, especially the mobile terminal, e.g., the cell phone, is a terminal which the driver of the motor vehicle carries with him, for instance.

In particular, this therefore provides the technical advantage that the message about the initiation of the electronic money transfer and the request for a confirmation of the money transfer, respectively, may be made available to the driver in efficient manner.

A communication network in terms of the specification includes, for example, a cellular network and/or a WLAN network.

According to a further specific embodiment, in addition, a license plate of the motor vehicle is compared to a reference license plate, the electronic money transfer being initiated only if the license plate of the motor vehicle agrees with the reference license plate.

For example, this results in the technical advantage that misuse may effectually be prevented, for now, according to this specific embodiment, two prerequisites must thus be present or two conditions must be satisfied, in order for the electronic money transfer to be initiated.

First of all, the detected face must match up with the reference face. Secondly, the license plate of the motor vehicle must agree with the reference license plate.

In accordance with this specific embodiment, the basis for the decision as to whether or not the electronic money transfer should be initiated is still additionally coupled to the motor vehicle. However, this possible disadvantage is compensated for and more than offset efficiently by the fact that a wrongful initiation of the electronic money transfer may effectively be rendered more difficult.

This is because, for example, a person who unlawfully wants to initiate the electronic money transfer would have to falsify not only a face, but also a license plate.

According to one specific embodiment, a photograph is taken of the motor vehicle, the license plate being detected in the photograph taken of the motor vehicle.

For example, it is provided to take a photograph of the motor vehicle including the driver, both the face of the driver and the license plate of the motor vehicle being detected in the photograph taken.

According to one specific embodiment, for example, two separate photographs are taken: one photo of the driver of the motor vehicle and one photo of the motor vehicle.

According to one specific embodiment, the method of the present invention is carried out or implemented with the aid of the apparatus according to the invention.

According to one specific embodiment, the apparatus of the present invention is designed or equipped to carry out or implement the method according to the invention.

Technical functionalities of the method are obtained analogously from corresponding technical functionalities of the apparatus and vice versa.

That means, in particular, that apparatus features are thus derived from corresponding method features and vice versa.

According to one specific embodiment, the parking facility includes an entrance.

According to one specific embodiment, the parking facility includes an exit.

According to one specific embodiment, at the entrance and at the exit, in each case a barrier is provided that is able to block the entrance or exit.

According to one specific embodiment, at the exit of the parking facility, a camera is provided for taking a photograph of a driver of a motor vehicle and/or of a motor vehicle.

According to one specific embodiment, the camera is a video camera.

For instance, the parking facility is a parking garage or a parking block.

A specifying within the meaning of the specification means, in particular, a determining or a defining.

In particular, the formulation “and . . . , respectively” includes the formulation “and/or.”

The present invention is explained in greater detail below on the basis of preferred exemplary embodiments.

### BRIEF DESCRIPTION OF THE DRAWINGS

FIG. 1 shows a flow chart of a method for executing an electronic money transfer.

FIG. 2 shows an apparatus for executing an electronic money transfer.

FIG. 3 shows a parking facility for motor vehicles.

### DETAILED DESCRIPTION OF EXAMPLE EMBODIMENTS

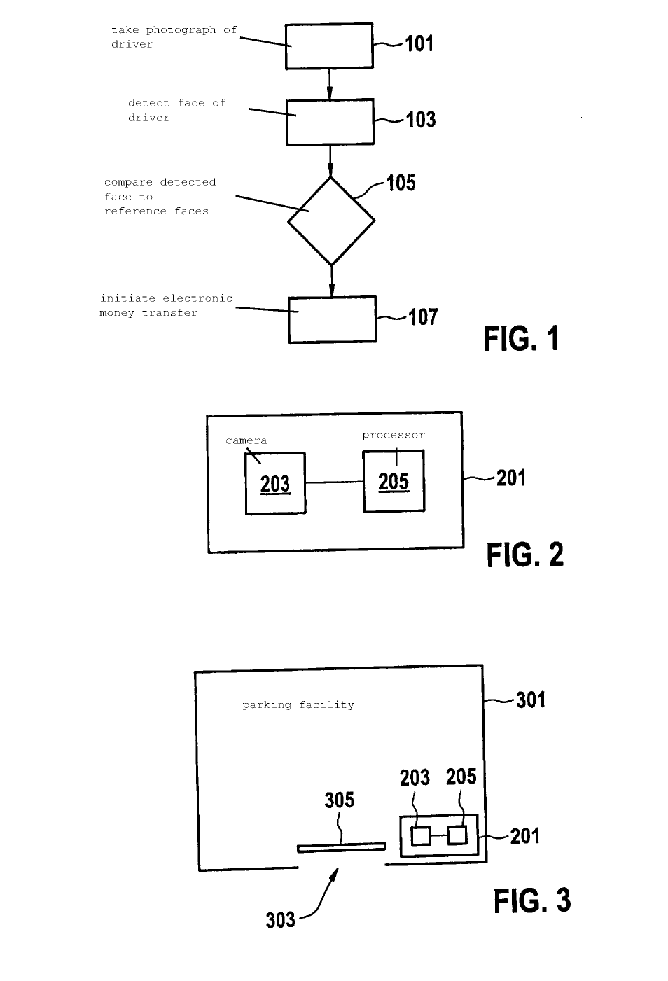

FIG. 1 shows a flow chart of an example method for executing an electronic money transfer, in order to pay a parking fee.

According to a step 101, a photograph is taken of a driver of a motor vehicle for which a parking fee must be paid.

For example, the driver is in the motor vehicle, and the motor vehicle is in front of a closed barrier at an exit of a parking facility when the photograph of the driver is taken.

According to one specific embodiment, the driver is photographed by a camera, e.g., by a video camera.

In a step 103, a face of the driver is detected in the photograph taken. For example, detection 103 includes a facial recognition.

According to a step 105, the detected face is compared to a reference face.

The reference face is stored in a database, for instance, which stores a multitude of reference faces.

For example, in the context of a registration process, the driver registers one time with his face. In other words, for instance, during a registration process, the face of the driver is thus photographed and stored as reference face in the database.

If the detected face agrees with the reference face, according to a step 107, an electronic money transfer is initiated to pay the parking fee.

If comparison 105 has shown that the detected face does not agree with the reference face, according to one specific embodiment, the driver of the motor vehicle is photographed again, steps 103 and 105 likewise being repeated. For this repeated photograph, it is provided, for instance, to illuminate the driver with a different lighting compared to the first photograph.

For instance, this provides the technical advantage that detection errors because of lighting which is not optimally adjusted may be eliminated.

If comparison 105 has shown that the detected face does not match up with the reference face (thus, e.g., in the case of an unknown face), according to one specific embodiment, an audio message and/or a visual message about the non-agreement is/are output with the aid of an infrastructure. For this, the infrastructure includes, for instance, an acoustic signal generator, e.g., a loudspeaker, and/or a visual signal generator, e.g., an electronic sign or a display screen.

If comparison 105 has shown that the detected face does not agree with the reference face (thus, e.g., in the case of an unknown face), according to one specific embodiment, the barrier blocking the exit of the parking facility remains closed, that is, does not open, so that the motor vehicle is unable to drive out of the parking facility, which is a parking garage, for example.

If, for instance, comparison 105 has shown that the detected face does not agree with the reference face, according to one specific embodiment, a message about the non-agreement is transmitted to a network address via a communication network. For instance, the network address is a network address of a mobile terminal, e.g., a cell phone, which the driver carries with him. Notably, this thereby yields the technical advantage that the driver may be informed efficiently that his face does not agree with a stored or registered reference face and/or that his face could not be recognized, so that the driver is then requested, for example, to pay manually by going to an automated pay machine, for instance, in order to pay the parking fee there.

FIG. 2 shows an apparatus 201 for executing an electronic money transfer, in order to pay a parking fee.

Apparatus 201 includes:
a camera 203 for taking a photograph of a driver of a motor vehicle for which a parking fee must be paid;
a processor 205 for detecting a face of the driver in the photograph taken and
for comparing the detected face to a reference face;
processor 205 being designed to initiate an electronic money transfer to pay the parking fee if the detected face agrees with the reference face.

According to one specific embodiment, processor 205 is designed to control a barrier at an exit of a parking facility in such a way that it opens if the comparison has shown that the detected face matches up with the reference face.

Thus, for example, processor 205 is designed to control a barrier at an exit of a parking facility.

According to one specific embodiment, apparatus 201 includes a communication interface.

According to one specific embodiment, the communication interface is designed, in the event the detected face matches up with the reference face, to transmit a message about the initiation of the electronic money transfer to a network address via a communication network.

According to one specific embodiment, the communication interface is designed, in the event the detected face agrees with the reference face, to transmit a request for a confirmation of the money transfer to a network address via a communication network prior to the initiation of the electronic money transfer.

According to one specific embodiment, the communication interface is designed to receive the confirmation via the communication network.

According to one specific embodiment, processor 205 is designed to initiate the electronic money transfer only upon receipt of the confirmation via the communication network.

According to one specific embodiment, camera 203 is designed to take a photograph of the motor vehicle.

According to one specific embodiment, processor 205 is designed to detect a license plate of the motor vehicle in the photograph taken of the motor vehicle.

According to one specific embodiment, processor 205 is designed to compare the detected license plate to a reference license plate.

According to one specific embodiment, processor 205 is designed to initiate the electronic money transfer only if the license plate of the motor vehicle agrees with the reference license plate.

According to one specific embodiment, a database is provided in which a multitude of reference faces are stored.

According to one specific embodiment, a multitude of reference license plates are stored in the database.

For example, as part of a registration process, the driver indicates one or more license plates for one or more motor vehicles as reference license plates.

FIG. 3 shows a parking facility 301 for motor vehicles.

Parking facility 301 includes a plurality of parking spaces (not shown), in which motor vehicles are able to park.

Parking facility 301 includes an exit 303, which may be blocked by a barrier 305.

Parking facility 301 includes apparatus 201 according to FIG. 2.

For example, one possible application scenario of the present invention is as follows:

After a parking time has ended, a driver drives his motor vehicle, parked within parking facility 301, to exit 303 and comes to a stop in front of closed barrier 305. Located at exit 303 is camera 203, which takes a photograph of the driver. Processor 205 detects the face of the driver in the photograph taken and compares this detected face to a reference face.

If the detected face agrees with the reference face, processor 205 initiates an electronic money transfer. Processor 205 subsequently controls barrier 305 in such a way that it opens, so that the driver is able to drive his motor vehicle out of parking facility 301.

It is, thus, made possible for the driver to park with several motor vehicles within parking facility 301.

According to one specific embodiment, exit 303 is free of a barrier. In other words, for example, no barrier 305 is therefore provided at exit 303. According to this specific embodiment, the driver is photographed by camera 203 while driving out of parking facility 301. The further steps of detecting the face, comparing, and initiating the electronic money transfer upon agreement are then analogous to the exemplary embodiments described above.

In one specific embodiment, if the detected face does not agree with the reference face, one or more actions are controlled and/or measures are initiated. One action or measure, for example, is to alert security personnel or the police. A further measure or action is, for example, to order up a towing service. Another measure is, e.g., to record a video of the situation in order to preserve evidence for a later time.

What is claimed is:

1. A method for executing an electronic money transfer in order to pay a parking fee, comprising:
taking a photograph of a driver of a motor vehicle for which a parking fee must be paid;
detecting a face of the driver in the photograph taken and;
comparing the detected face to a reference face;
initiating an electronic money transfer to pay the parking fee if the detected face agrees with the reference face.

2. The method as recited in claim 1, wherein the photograph is taken at an exit of a parking facility blocked by a barrier, the barrier opening automatically after the initiation (107) of the electronic money transfer, in order to allow the motor vehicle to exit.

3. The method as recited in claim 1, wherein in the event the detected face agrees with the reference face, a message about the initiation of the electronic money transfer is transmitted to a network address via a communication network.

4. The method as recited in claim 1, wherein in the event the detected face agrees with the reference face, prior to the initiation of the electronic money transfer, a request for a confirmation of the money transfer is transmitted to a network address via a communication network, the electronic money transfer being initiated only upon receipt of the confirmation via the communication network.

5. The method as recited in claim 1, further comprising:
comparing a license plate of the motor vehicle to a reference license plate, the electronic money transfer being initiated only if the license plate of the motor vehicle agrees with the reference license plate.

6. An apparatus for executing an electronic money transfer in order to pay a parking fee, comprising:
a camera for taking a photograph of a driver of a motor vehicle for which a parking fee must be paid; and
a processor for detecting a face of the driver in the photograph taken and for comparing the detected face to a reference face, the processor being designed to initiate an electronic money transfer to pay the parking fee if the detected face agrees with the reference face.

7. A parking facility for motor vehicles, including the apparatus for executing an electronic money transfer in order to pay a parking fee, comprising:
a camera for taking a photograph of a driver of a motor vehicle for which a parking fee must be paid; and
a processor for detecting a face of the driver in the photograph taken and for comparing the detected face to a reference face, the processor being designed to initiate an electronic money transfer to pay the parking fee if the detected face agrees with the reference face.

8. A non-transitory computer-readable storage medium on wick is stored a computer program including program code for executing an electronic money transfer in order to pay a parking fee, the computer program, when executed by a computer, causing the computer to perform:
taking a photograph of a driver of a motor vehicle for which a parking fee must be paid;
detecting a face of the driver in the photograph taken;
comparing the detected face to a reference face; and
initiating an electronic money transfer to pay the parking fee if the detected face agrees with the reference face.
